(19) United States
(12) Patent Application Publication
(10) Pub. No.: US 2009/0300307 A1
(43) Pub. Date: Dec. 3, 2009

(54) PROTECTION AND SECURITY PROVISIONING USING ON-THE-FLY VIRTUALIZATION

(75) Inventors: Martim Carbone, Atlanta, GA (US); Bernhard Jansen, Rueschlikon (CH); HariGovind V. Ramasamy, Tarrytown, NY (US); Matthias Schunter, Zurich (CH); Axel Tanner, Kilchberg (CH); Diego Zamboni, Adliswil (CH)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/130,159

(22) Filed: May 30, 2008

(51) Int. Cl. G06F 12/16

(52) U.S. Cl. 711/163; 711/E12.103

(57) ABSTRACT

A virtualization layer is inserted between (i) an operating system of a computer system, and (ii) at least one of a memory module and a storage module of the computer system. At least one of read access and write access to at least one portion of the at least one of a memory module and a storage module is controlled, with the virtualization layer. The insertion of the virtualization layer is accomplished in an on-the-fly manner (that is, without rebooting the computer system) An additional aspect includes controlling installation of a security program from the virtualization layer.

### FIELD OF THE INVENTION

The present invention relates to the electrical, electronic and computer arts, and, more particularly, to computer security and the like.

### BACKGROUND OF THE INVENTION

In a conventional computer system, the operating system installed on the computer accesses hardware devices directly. The piece of software inside an operating system that communicates with the hardware is known as a device driver. In a virtualized system, the operating system does not access the hardware devices directly; instead it communicates with virtual devices provided by the hypervisor, which in turn communicates with the real hardware. The hypervisor can act as a transparent proxy to the hardware (simply relaying access requests from the operating system).

The protection of processes and/or data has become of increasing significance, as has the provisioning of security functions, given the increase in malicious attacks on computer systems by hackers and the like. Previous attempts to use virtualization for security have required pre-configuration of the system to be protected.

### SUMMARY OF THE INVENTION

Principles of the present invention provide techniques for protection and security provisioning using on-the-fly virtualization. In one aspect, an exemplary method (which can be computer implemented) includes the steps of: inserting a virtualization layer between (i) an operating system of a computer system, and (ii) a memory module and/or a storage module of the computer system; and controlling read and/or write access to at least one portion of the memory module and/or storage module, with the virtualization layer. The insertion of the virtualization layer is accomplished in an on-the-fly manner (that is, without rebooting the computer system). It should be noted that in one or more embodiments, the virtualization layer is not inserted between the operating system and just specific hardware elements (such as memory and/or storage modules), but rather under the whole operating system, mediating its access to the entire set of hardware (including, but not limited to, memory and/or storage modules).

In another aspect, an exemplary method (which can be computer implemented) includes the steps of: inserting a virtualization layer between (i) an operating system of a computer system, and (ii) at least one of a memory module and a storage module of said computer system; and controlling installation of a security program from said virtualization layer. The insertion of said virtualization layer is accomplished in an on-the-fly manner.

One or more embodiments of the invention or elements thereof can be implemented in the form of a computer product including a computer usable medium with computer usable program code for performing the method steps indicated. Furthermore, one or mole embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

One or more embodiments of the invention may offer one or more of the following technical benefits: addressing security issues without the need for system reboot; on-demand insertion of security functionality tailored to current threats; limiting success and/or enhancing detectability of rootkit attacks; limiting success and/or enhancing detectability of other security attacks against the system; and enabling a virtual trusted platform module for high-volume authentication.

These and other features, aspects and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary inventive system during normal operation;

FIG. 2 shows the exemplary system of FIG. 1 after on-the-fly insertion of a virtualization layer, according to an aspect of the invention;

FIG. 3 shows an exemplary application of the system of FIG. 2, directed to run-time protection of data and processes;

FIG. 4 shows an exemplary application of the system of FIG. 2, directed to run-time provisioning of security functions;

FIG. 5 shows a flow chart of an exemplary method, according to another aspect of the invention; and

FIG. 6 depicts a computer system that may be useful in implementing one or more aspects and/or elements of the present invention.

### DETAILED DESCRIPTION OF PREFERRED EMBODIMENTS

One or more embodiments of the invention address one or more of: (i) protecting processes and data from malicious software, and (ii) provisioning of security functionality, in each case, through on-the-fly virtualization. Heretofore, use of a virtualization layer for improving security has required the system to be pre-configured to benefit from the virtualization layer. In one or more embodiments of the invention, the virtualization layer with appropriate protection logic and/or security functionality is inserted on-the-fly (i e., at run-time) without affecting the normal operation of the operating system and other software running on top of the operating system.

Since it is not always possible to predict all software that may be run on a system, and the potentially malicious effects of such unknown software, one or more embodiments of the invention provide an “on-demand way” to insert a protection logic that is tailored to counter currently-known threats to the system. Moreover, on-the-fly virtualization does not require system reboot; hence, using one or more embodiments of the invention, instead of existing solutions, allows protection to be added to the system in an availability-preserving way.

As noted, in some instances, a virtualization layer can act as a transparent proxy to the hardware (simply relaying access requests from the operating system), but in one or more embodiments of the invention, it can be used to encode protection logic and provide security functionality. The virtualization layer, according to one or more embodiments of the invention, is a layer of software between the operating system and the hardware, performing one or more inventive activities as described herein. In some instances, the virtualization layer may be a specific piece of software written for a specific purpose. In other instances, the on-the-fly protection and/or provisioning (or other) functionality of the virtualization layer is added to a traditional “hypervisor” (a layer between the operating system and the hardware that allows multiple operating systems to run on the hardware (HW) the same time).

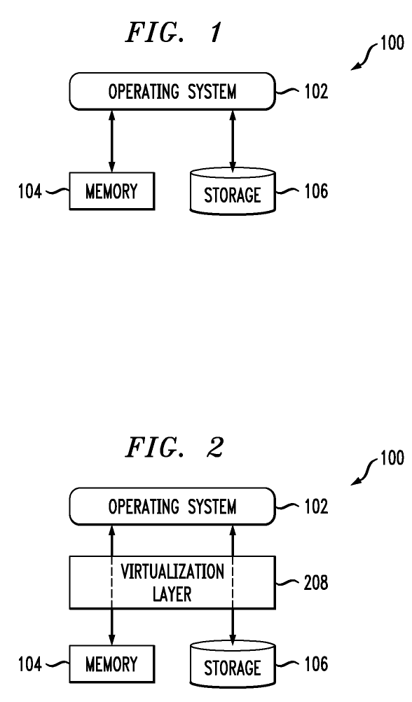

Reference should now be had to FIGS. 1 and 2. FIG. 1 shows an exemplary inventive system 100 prior to insertion of a virtualization layer System 100 includes operating system (OS) 102 and hardware such as memory module 104 (for example, random access memory (RAM) and/or read-only memory (ROM)) and/or storage module 106 (for example, non-volatile memory such as a hard drive). As seen in FIG. 2, on-the-fly hardware virtualization is a technique by which a thin virtualization layer 208 is introduced seamlessly between the operating system 102 and the physical hardware, such as elements 104, 106. Here, “seamless” means that the procedure does not require operating system restart. In a non-limiting exemplary embodiment, operating system 102 is the well-known Linux operating system.

In one non-limiting exemplary application, an inventive virtualization layer 208 can be used for run-time protection of data and processes. In one or more embodiments, layer 208 operates below the OS 102 and can be introduced on-the-fly, and thus can be used for run-time protection of processes and/or data from other processes and even from the OS 102 itself. Such functionality can be effectuated, for example, by creating an enclave (such as 310 and 316, discussed below) for the processes and/or data and controlling external access to that enclave through layer 208.

Unlike prior techniques which have sought to use a virtualization layer for access control, one or more embodiments of the invention enable such use with run-time introduction. Furthermore, prior attempts to introduce access control dynamically at the OS level or application level (for example, OS patches and firewall rule updates) have limited effectiveness (i) once the OS itself has been compromised and (ii) against rootkit attacks. One or more embodiments of the invention allow access control logic to be implemented, so as to provide write protection and/or read protection of memory 104 and storage 106.

With regard to write protection, note that rootkits have a good degree of success in avoiding detection by malicious code detection tools deployed at the OS level. This is because many rootkits modify the core OS itself, for example, system binaries, kernel data structures, and system libraries. By using one or more embodiments of virtualization layer 208 to write-protect important system software and data structures, rootkit attacks can be prevented from becoming fully successful, or at least be prevented from escaping detection by standard detection tools.

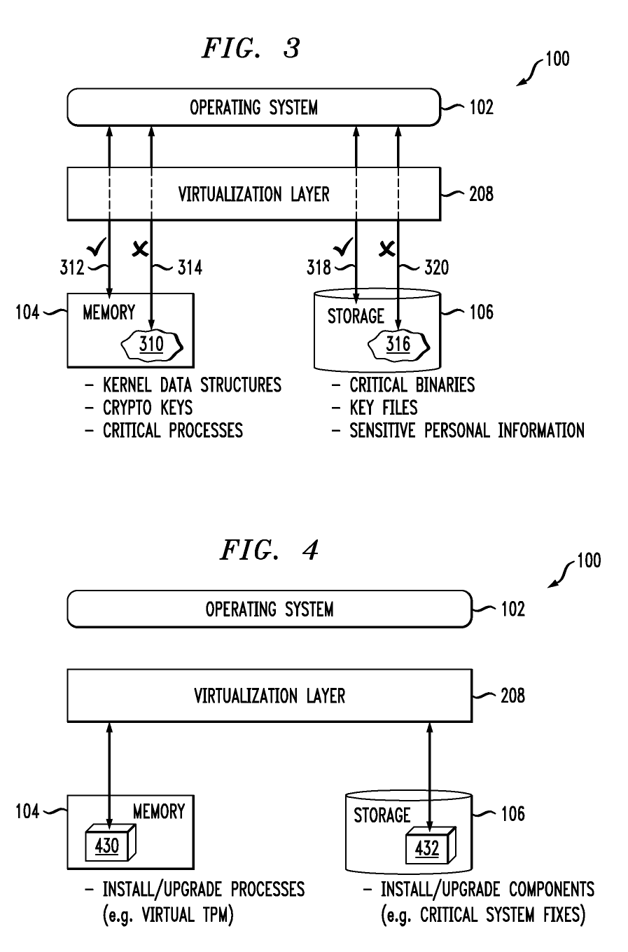

As seen in FIG. 3, after on-the-fly installation, virtualization layer 208 can intercept all accesses to memory 104 and storage 106. It can interpret and traverse the data structures used by the operating system to represent active processes and obtain information, such as the location 310 in memory 104, pertaining to certain processes of interest. Virtualization layer 208 can then mark memory regions, such as region 310, in which these data structures are loaded as “protected.” Thereafter, virtualization layer 208 can check whether any memory write-request is to a “protected” region, and if so, it can deny the request. Note arrow 312 with an adjacent check mark, indicating that a write to memory 104 outside region 310 is allowed by layer 208. Note also arrow 314 with adjacent “X” mark, indicating that a write to memory 104 inside region 310 is not allowed by layer 208. Non-limiting examples of material to be write-protected in region 310 include kernel data structures, cryptographic (“crypto”) keys, and/or critical processes. Similar write protection can also be enabled for a region 316 in storage 106. Note arrow 318 with an adjacent check mark, indicating that a write to storage 106 outside region 316 is allowed by layer 208. Note also arrow 320 with adjacent “X” mark, indicating that a write to storage 106 inside region 316 is not allowed by layer 208. Non-limiting examples of material to be write-protected in region 316 include critical binaries, key files, and sensitive personal information.

New rootkits are released all the time. Since it is not possible to anticipate all possible attack methods in advance and pre-configure the system 100 to deal with those methods, virtualization layer 208 provides a way to tailor the protection method at run-time based on the latest attack methods.

With regard to read protection, note that one or more embodiments of virtualization layer 208 can be used to guard any location in memory 104 or disk block (exemplary of a location in storage 106) against access by the OS 102. For example, layer 208 can provide lead protection for arbitrary keys (for example, digital lights management (DRM) keys) stored in location 310. Such a feature would be particularly useful for protecting and effectively isolating a virtual trusted platform module or TPM (that is, a software emulation of a hardware TPM) from the OS 102. In general, material in region 310 of memory 104 and/or region 316 of storage 106 could be read-protected (in addition to or instead of being write-protected), as indicated by the double-headed nature of arrows 312, 314, 318, 320. Furthermore, there can be more than one protected region in memory 104 and/or storage 106, and material to be read-protected need not necessarily be in the same protected region as material to be write-protected.

A non-limiting example of a trigger for installation of virtualization layer 208 is the installation of a security-critical program. For example, virtualization layer 208, offering read-protection, may be installed as part of the installation of a security-critical program that needs to store some sensitive information in memory 104. At the end of the installation, virtualization layer 208 becomes “alive” and pushes the OS 102 into a virtual machine. Similarly, virtualization layer 208 offering write-protection may be installed as part of the installation of security-critical software, thus providing a way to safeguard the software against any modification.

In another non-limiting exemplary application, an inventive virtualization layer 208 can be used for run-time provisioning of security functions. Reference should be had to FIG. 4. Virtualization layer 208 can also be used for run-time installation of new security functions. A difference between (i) controlling the installation from virtualization layer 208, and (ii) controlling the installation from the OS 102, is that it is possible to enforce stricter timing on the updates when installing from virtualization layer 208. If the installation is controlled from the OS 102, it is possible for the user to delay a critical update indefinitely. In one or more embodiments of the invention, since virtualization layer 208 operates below the OS 102, it is not be possible for the user to cause such a delay.

By way of a non-limiting example, suppose that high-volume authentication functionality is needed by a system, such as system 100. Then, a full software (virtual) TPM can be installed at run-time as part of the installation of virtualization layer 208. The software TPM, thus installed, can have more flexible functionality than a hardware TPM, while retaining a significant advantage of the hardware TPM, that is, tamper protection from the OS 102 and from applications. Since it is a software implementation, such a TPM can be used for high-volume authentication, for which today's hardware TPMs cannot be used. Installation and/or upgrade of processes in memory 104, such as installation of the aforementioned virtual TPM, is depicted at location 430 in FIG. 4. Installation and/or upgrade of components in storage 106, such as critical system fixes, is depicted at location 432 in FIG. 4.

In one or more embodiments, the virtualization layer can be installed on the fly. In the prior art, so-called “HyperJacking” techniques have been used to insert a software layer in a running system, for purposes of intrusion detection, without the need to reboot. Such techniques can be modified by the skilled artisan, given the teachings herein, to permit on-the-fly installation of the virtualization layer 208; other techniques for installing the virtualization layer may also be employed.

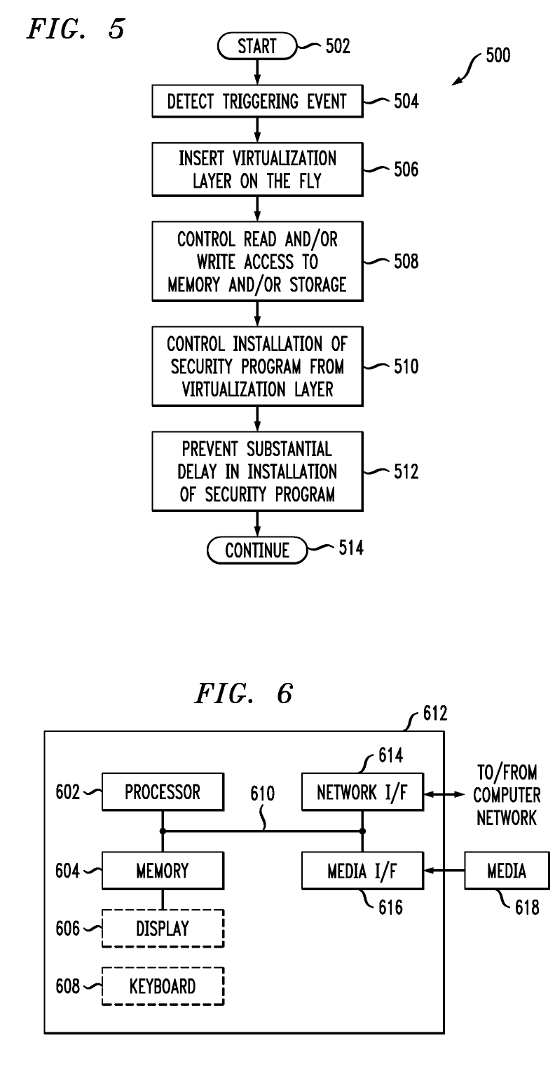

In view of the description of FIGS. 1-4, and with reference now to FIG. 5, it will be appreciated that, in general terms, an exemplary method (which can be computer-implemented), depicted in flow chart 500, according to an aspect of the invention, includes the step of inserting a virtualization layer between (i) an operating system 102 of a computer system 100, and (ii) a memory module 104 and/or a storage module 106 of the computer system, as at block (step) 506. An additional step includes controlling at least one of read access and write access to at least one portion 310, 316 of the memory module and/or storage module, with the virtualization layer 208, as at block 508. The insertion of the virtualization layer 208 in block 506 is accomplished in an on-the-fly manner.

Note that not all steps in FIG. 5 are necessarily needed. For example, any or all of steps 508, 510 and 512 can be done independently of each other.

In some instances, after beginning at block 502, a triggering event can be detected, as at block 504. Non-limiting examples of such events include installation of a security-critical program which needs to store sensitive information in the memory module and detecting imminent installation of a security-critical program which needs to be stored in the storage module. The insertion in block 506 may be carried out in response to the detecting in block 504

Material to be read and/or write protected in portion 310 can include, by way of example and not limitation, the aforementioned kernel data structures, cryptographic keys, and/or critical processes; indeed, any important data structure in memory, or any region of memory in general. Material to be read and/or write protected in portion 316 can include, by way of example and not limitation, the aforementioned critical binaries, key files, and/or sensitive personal information; indeed, any important or critical file, or any file in general.

In some instances, an additional step includes controlling installation of a security program from the virtualization layer 208, as at block 510. Furthermore, as indicated at block 512, in some embodiments, the virtualization layer 208 is configured to prevent substantial delay in the installation of the security program. A non-limiting example of a security program is the aforementioned virtual trusted platform module (TPM). The TPM can have its installation controlled by the virtualization layer. The flow continues at block 514. Again, it is to be emphasized that any or all of steps 508, 510 and 512 can be done independently of each other; security provisioning is independent from lead/write protection. Thus, one or more methods according to various embodiments of the invention can include any one, any two, or all three of steps 508, 510, 512

Exemplary System and Article of Manufacture Details

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. In connection with FIG. 6, the term “memory” is intended to include memory associated with a processor or CPU, such as, for example, RAM (random access memory), ROM (read only memory), a fixed memory device (for example, hard drive), a removable memory device (for example, diskette), a flash memory and the like (note the distinction between memory and storage in connection with the other figures). In addition, the phrase “input/output interface” as used herein, is intended to include, for example, one or more mechanisms for inputting data to the processing unit (for example, mouse), and one or more mechanisms for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU Such software could include, but is not limited to, firmware, resident software, microcode, and the like.

Furthermore, the invention can take the form of a computer program product accessible from a computer-usable or computer-readable medium (for example, media 618) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a computer-readable medium include a semiconductor or solid-state memory (for example memory 604), magnetic tape, a removable computer diskette (for example media 618), a random access memory (RAM), a read-only memory (ROM), a rigid magnetic disk and an optical disk. Current examples of optical disks include compact disk-read only memory (CD-ROM), compact disk-read/write (CD-RAW) and DVD.

A data processing system suitable for storing and/or executing program code will include at least one processor 602 coupled directly or indirectly to memory elements 604 through a system bus 610. The memory elements can include local memory employed during actual execution of the program code, bulk storage, and cache memories which provide temporary storage of at least some program code in order to reduce the number of times code must be retrieved from bulk storage during execution

Input/output or I/O devices (including but not limited to keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code will typically execute on the computer to be protected.

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes fox implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. For example, some systems may offer hardware support for virtualization.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related alt will be able to contemplate other implementations of the components of the invention.

It will be appreciated and should be understood that the exemplary embodiments of the invention described above can be implemented in a number of different fashions. Given the teachings of the invention provided herein one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
inserting a virtualization layer between (i) an operating system of a computer system, and (ii) at least one of a memory module and a storage module of said computer system; and
controlling at least one of read access and write access to at least one portion of said at least one of a memory module and a storage module, with said virtualization layer;
wherein said insertion of said virtualization layer is accomplished in an on-the-fly manner.

2. The method of claim 1, wherein:
said insetting comprises insetting said layer between said operating system and said memory module; and
said controlling comprises controlling read access to said at least one portion, said at least one portion being a portion of said memory module.

3. The method of claim 2, wherein said portion contains an important data structure.

4. The method of claim 2, wherein said portion contains cryptographic keys.

5. The method of claim 2, wherein said portion contains critical processes.

6. The method of claim 2, further comprising the additional step of detecting imminent installation of a security-critical program which needs to store sensitive information in said memory module, wherein said inserting is carried out in response to said detecting.

7. The method of claim 1, wherein:
said insetting comprises inserting said layer between said operating system and said memory module; and
said controlling comprises controlling write access to said at least one portion, said at least one portion being a portion of said memory module.

8. The method of claim 7, wherein said portion contains kernel data structures.

9. The method of claim 7, wherein said portion contains cryptographic keys.

10. The method of claim 7, wherein said portion contains critical processes.

11. The method of claim 1, wherein:
said inserting comprises inserting said layer between said operating system and said storage module; and
said controlling comprises controlling read access to said at least one portion, said at least one portion being a portion of said storage module.

12. The method of claim 11, wherein said portion contains an important file.

13. The method of claim 11, wherein said portion contains key files.

14. The method of claim 11, wherein said portion contains sensitive personal information.

15. The method of claim 1, wherein:
said inserting comprises inserting said layer between said operating system and said storage module; and
said controlling comprises controlling write access to said at least one portion, said at least one portion being a portion of said storage module.

16. The method of claim 15, wherein said portion contains critical binaries.

17. The method of claim 15, wherein said portion contains key files.

18. The method of claim 15, wherein said portion contains sensitive personal information.

19. The method of claim 15, further comprising the additional step of detecting imminent installation of a security-critical program which needs to be stored in said storage module, wherein said insetting is carried out in response to said detecting

20. A method comprising the steps of:
inserting a virtualization layer between (i) an operating system of a computer system, and (ii) at least one of a memory module and a storage module of said computer system; and
controlling installation of a security program from said virtualization layer;
wherein said insertion of said virtualization layer is accomplished in an on-the-fly manner.

21. The method of claim 20, wherein said virtualization layer is configured to prevent substantial delay in said installation of said security program.

22. The method of claim 20, wherein said security program comprises a virtual trusted platform module.

23. A computer program product comprising a computer useable medium including computer usable program code, said computer program product including:
computer usable program code for inserting a virtualization layer between (i) an operating system of a computer system, and (ii) at least one of a memory module and a storage module of said computer system; and
computer usable program code for controlling installation of a security program from said virtualization layer;
wherein said computer usable program code for inserting said virtualization layer is configured to accomplish said insertion in an on-the-fly manner.

24. A computer program product comprising a computer useable medium including computer usable program code, said computer program product including:
computer usable program code for inserting a virtualization layer between (i) an operating system of a computer system, and (ii) at least one of a memory module and a storage module of said computer system; and
computer usable program code for controlling at least one of read access and write access to at least one portion of said at least one of a memory module and a storage module, with said virtualization layer;
wherein said computer usable program code for inserting said virtualization layer is configured to accomplish said insertion in an on-the-fly manner.

25. A system comprising:
a memory; and
at least one processor, coupled to said memory, and operative to
insert a virtualization layer between (i) an operating system of a computer system, and (ii) at least one of a memory module and a storage module of said computer system; and
control at least one of read access and write access to at least one portion of said at least one of a memory module and a storage module, with said virtualization layer;
wherein said processor is operative to insert said virtualization layer in an on-the-fly manner.
